(19) United States
(12) Patent Application Publication
(10) Pub. No.: US 2017/0028989 A1
(43) Pub. Date: Feb. 2, 2017

(54) Temporary Parking for Motorized Vehicles

(71) Applicants: Meera Thillainatesan, Unionville, CT (US); Suthaharan Sivasubramaniam, Unionville, CT (US)

(72) Inventors: Meera Thillainatesan, Unionville, CT (US); Suthaharan Sivasubramaniam, Unionville, CT (US)

(21) Appl. No.: 14/813,114

(22) Filed: Jul. 29, 2015

(51) Int. Cl. B60W 30/18

(52) U.S. Cl. CPC B60W 30/18054

(57) ABSTRACT

A Temporary Parking function in motorized vehicles may be driver activated or computer activated. When Temporary Parking is activated, a stationary vehicle will remain stationary until Temporary Parking is deactivated. Temporary Parking will be deactivated by the application of the accelerator pedal. There is no need to change gears when activating or deactivating Temporary Parking in one embodiment.

### BACKGROUND OF THE INVENTION

Motorized vehicles in drive gear rely on the driver to apply pressure to the brake pedal in order to remain stationary. Lifting the foot off the brake pedal, even slightly, causes the motorized vehicle to move forward. A distracted driver who fails to apply pressure to the brake pedal will find their vehicle unexpectedly moving.

Accidents happen when a driver's attention is diverted. When a motorized vehicle is temporarily stopped, at a stop sign or a red traffic light, drivers are more receptive to distractions inside and outside the vehicle. At such a time, the pressure the driver is applying on the brake pedal can lessen, and the motorized vehicle can move forward or backward unexpectedly.

With the advent of navigation technology and cellular technology, there has been an increase in distractions to the drivers of motorized vehicles. Drivers are prone to refer to their navigation or cellular devices when their vehicle is momentarily stopped.

There are two important statistics about the use of navigation and cellular devices in such instances. According to the National Occupant Protection Use Survey (NOPUS), which is conducted by the National Center for Statistics and Analysis of the National Highway Traffic Safety Administration (NHTSA), for the year 2011:
1) 5% of all drivers of passenger vehicles with no commercial or government markings that were stopped at a stop sign or stoplight between the hours of 7 am and 6 pm were holding a phone to their ears.
2) 1.3% of all drivers of passenger vehicles with no commercial or government markings that were stopped at a stop sign or stoplight between the hours of 7 am and 6 pm were manipulating hand-held devices.

The above statistics measure only the distractions attributed to the use of navigation and cellular devices at stop signs and stoplights. The contribution of these and the other distractions available to drivers create a dangerous situation for society. Distraction affected crashes constitute ten percent of fatal crashes, eighteen percent of injury crashes, and sixteen percent of all motor vehicle crashes in 2012, according to the NHTSA's Traffic Safety Facts Research Note titled “Distracted Driving 2012.”

Currently, a driver who wishes to remain stationary has only one option, other than to keep pressing hard on the brake pedal. The option is to change gear to Park. When the stoplight changes to green or when the driver is ready to move the vehicle, the driver cannot just apply the accelerator. The driver must first press the brake pedal. Next the driver must change gear from Park to Drive. Finally the driver can apply the accelerator pedal. Only then will the vehicle move.

### BRIEF SUMMARY OF THE INVENTION

The present invention includes a temporary parking function in motorized vehicles. Temporary Parking may be either driver or computer activated when a vehicle's speed is zero miles per hour. When Temporary Parking is activated, the vehicle will remain stationary until Temporary Parking is deactivated. Temporary Parking will be deactivated by the application of the accelerator pedal. There is no need to change gears when activating or deactivating Temporary Parking in one embodiment.

In differing models of motorized vehicles, Temporary Parking may be activated by the driver's foot, hand or verbal command, or by the computer sensing that the speed of the vehicle is zero miles per hour for a predetermined length of time. Another embodiment allows the driver to initiate computer activated Temporary Parking.

### BRIEF DESCRIPTION OF THE SEVERAL VIEWS OF THE DRAWING

FIG. 1 is a flowchart showing one operation of driver activated Temporary Parking (briefly TP).

FIG. 2A is a flowchart showing one operation of a computer activated Temporary Parking function.

FIG. 2B is a flowchart showing how a driver may initiate computer activated Temporary Parking in a Temporary Parking Mode.

FIGS. 3A and 3B are flowcharts comparing a vehicle using Temporary Parking to a vehicle using Park gear.

FIG. 4A is a representation of a display console allowing a driver to select operational settings for a computer activated Temporary Parking function in one embodiment of the present invention.

FIG. 4B is a representation of another embodiment of the present invention whereby a driver can select to activate Temporary Parking by hand.

### DETAILED DESCRIPTION OF THE INVENTION

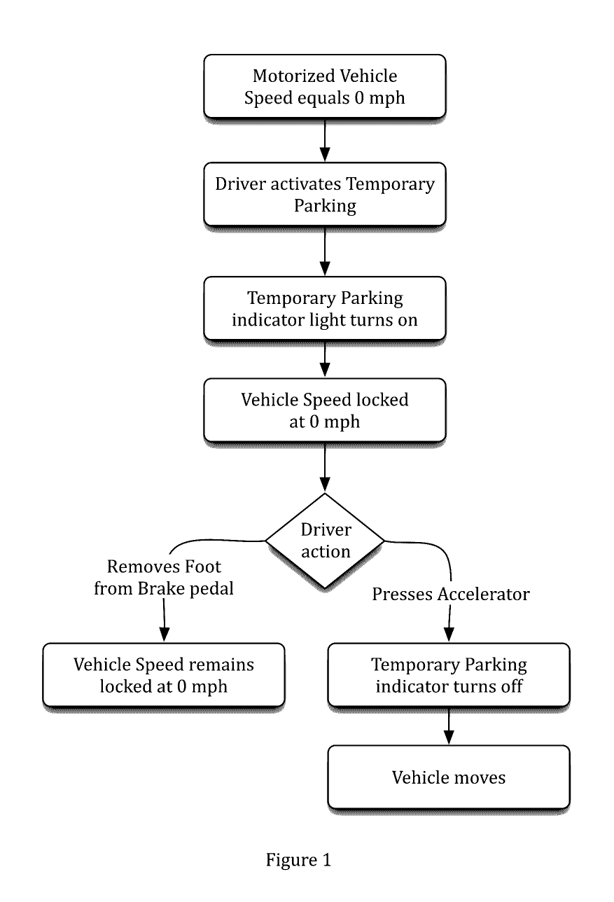

One embodiment of the present invention is driver activated Temporary Parking, as illustrated in FIG. 1. When the motorized vehicle is at a complete stop, the driver may activate Temporary Parking. Depending on the make of the motorized vehicle, Temporary Parking may be activated by foot, hand or verbal command. When Temporary Parking is activated, the motorized vehicle will remain stationary as if the driver was continuing to apply the brake pedal or any mechanism that prevents the vehicle from moving. In one embodiment, this is accomplished by reducing fuel supply to the engine, and in another by disengaging the engine from the transmission.

The driver may lessen pressure to or remove their foot from the brake pedal at this point, and the motorized vehicle will remain stationary. Depending on the motorized vehicle, there may be an indicator light that illuminates when Temporary Parking is activated.

Temporary Parking is deactivated by application of the accelerator pedal. The temporary nature of Temporary Parking is due to the fact that application of the accelerator pedal deactivates Temporary Parking and allows the car to move.

As illustrated in FIG. 1, when the driver wants the motorized vehicle to move, the driver applies the accelerator pedal. Temporary Parking is disabled. Any mechanism in place to prevent movement is disabled and any mechanism to start movement is initiated. In one embodiment, this is accomplished by increasing fuel supply to the engine, and in another by engaging the engine to the transmission. The vehicle may move.

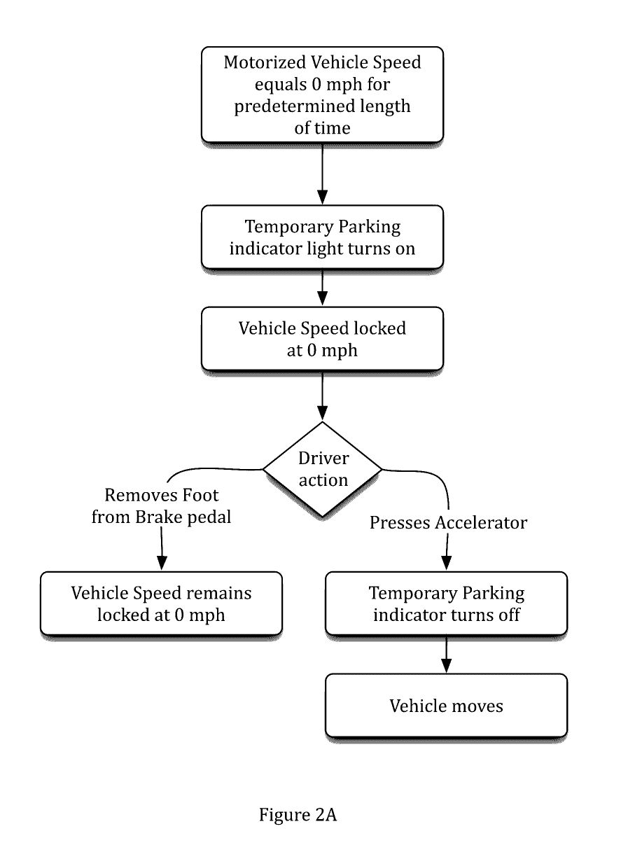

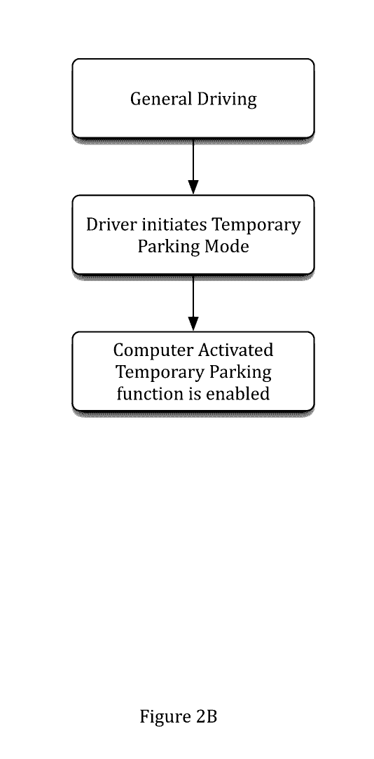

Another embodiment of the present invention is a computer activated Temporary Parking function, as illustrated in FIG. 2A. When the onboard computer or software of the motorized vehicle detects that the vehicle has been at a complete stop for a predetermined amount of time, the onboard computer may itself activate Temporary Parking. When Temporary Parking is activated, the motorized vehicle will remain stationary even if the driver reduces pressure to the brake pedal or removes the foot from the brake pedal. Depending on the make of the motorized vehicle, an indicator light may be activated.

The advantage of a computer activated Temporary Parking function is that all the benefits of Temporary Parking will be delivered even if the driver is too distracted to apply Temporary Parking on his/her own terms. In addition, many motorized vehicles already have a sensor to detect if the motorized vehicle is stationary.

The flowchart in FIG. 2A begins with the motorized vehicle at a complete stop. If the onboard sensor detects that the vehicle has been stationary for a predetermined interval of time, the onboard software activates Temporary Parking. An indicator light may be illuminated now and the driver may lessen pressure to the brake pedal.

When the driver wants the motorized vehicle to move, he applies the accelerator pedal. Temporary Parking is disabled, and the Temporary Parking indicator may be cancelled now. The vehicle can move.

FIG. 2B shows one embodiment of a Temporary Parking Mode in which the driver can choose to initiate the computer activated Temporary Parking function described above. When Temporary Parking Mode is initiated by the driver, the computer will activate Temporary Parking each time the vehicle speed measures zero miles per hour for the predetermined length of time. During the operation of Temporary Parking Mode, the driver need not activate Temporary Parking each time the vehicle stops at a red light. If the driver wishes to choose when to activate Temporary Parking, the driver may turn off the Temporary Parking Mode.

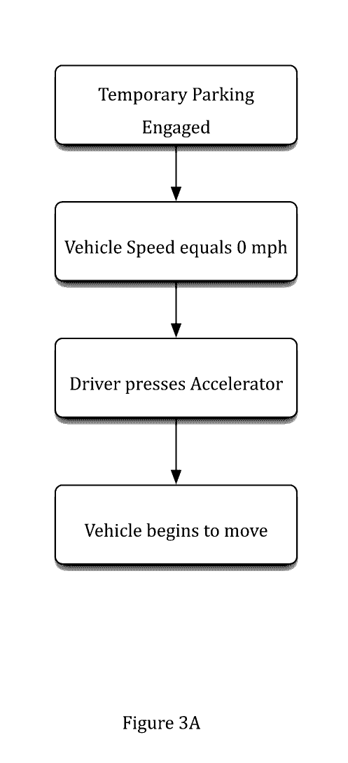

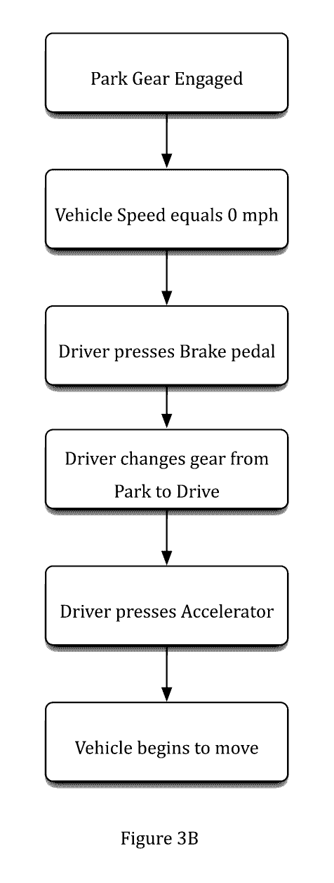

FIGS. 3A and 3B illustrate how Temporary Parking differs from Park gear with respect to how the two are deactivated. In order to move the motorized vehicle from Temporary Parking, only the accelerator pedal needs to be applied. The process of moving the motorized vehicle from Park gear involves more steps than simply applying the accelerator pedal.

As illustrated in FIG. 3A, the motorized vehicle is at a complete stop and the driver has engaged Temporary Parking. Vehicle speed is locked at zero miles per hour. The driver may lessen pressure to the brake pedal. When the driver wants the motorized vehicle to move, he applies the accelerator pedal. Temporary Parking is disabled. The vehicle may move.

In FIG. 3B, the motorized vehicle is at a complete stop and the driver has engaged the Park gear. Vehicle speed is locked at zero miles per hour. The driver may lessen pressure to the brake pedal. When the driver wants the motorized vehicle to move, he first applies the brake pedal. Next he changes gear to Drive while applying the brake pedal. Finally he applies the accelerator pedal. The vehicle may move.

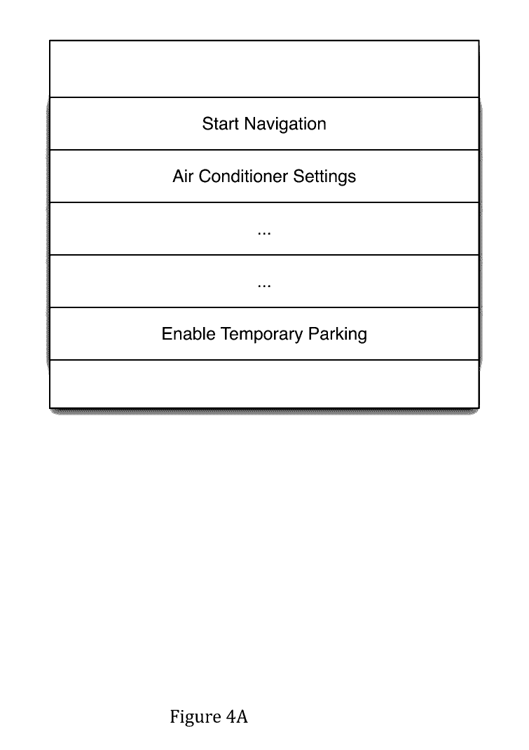

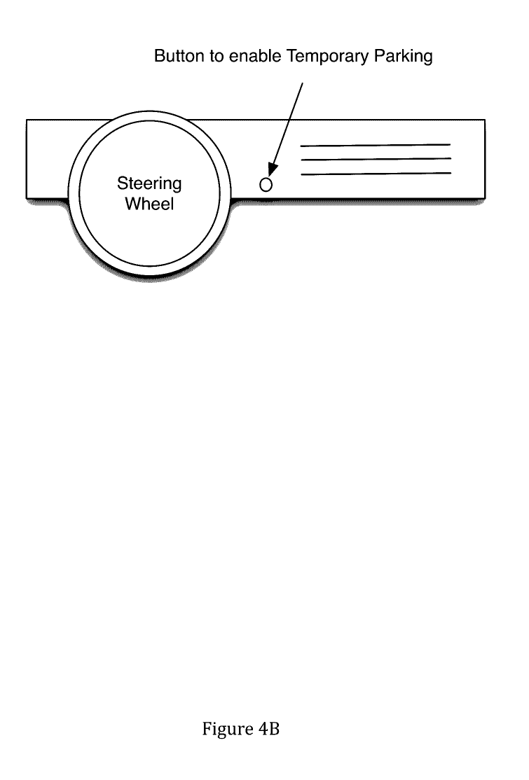

FIG. 4A shows a display console allowing the selection, by hand or voice, of operational settings for Temporary Parking Mode in some motorized vehicles that have a display console. FIG. 4B illustrates one embodiment enabling drivers to select Temporary Parking by hand. Another embodiment would enable drivers to select Temporary Parking by foot.

The advantage of some of the embodiments shown in the figures will be briefly described. Accidents can happen when a driver's attention is diverted. When a motorized vehicle is stationary, at a stop sign or a red traffic light, drivers may be more receptive to distractions. Examples of distractions include food, audio controls, external objects, cellular technology, cosmetics, navigation technology and passengers in the vehicle. At such a time, the pressure the driver is applying on the brake pedal can lessen. The motorized vehicle can move unexpectedly into a nearby car, pedestrian, bicycle or other object.

If one embodiment of Temporary Parking is activated, a motorized vehicle will remain stationary even if the driver becomes distracted and removes their foot from the brake pedal.

What is claimed is:

1. A temporary parking function in motorized vehicles comprising:
a means of activation by the driver of the motorized vehicle when the vehicle is at a complete stop, whereby the vehicle is made to remain at a complete stop;
a means of deactivation by the driver of the vehicle by application of the accelerator.

2. A computer activated temporary parking function in motorized vehicles comprising:
an onboard system for detecting when the vehicle speed measures zero miles per hour for a predetermined interval of time;
a means of activation by said onboard system when the vehicle speed measures zero miles per hour for the predetermined interval of time, whereby the motorized vehicle is made to remain at a complete stop;
a means of deactivation by the driver of the vehicle by application of the accelerator.

3. A temporary parking mode in motorized vehicles comprising:
a means of activation of the method of claim 2 by the driver of the vehicle;
a means of deactivation by the driver of the vehicle.
